(19) United States
(12) Patent Application Publication
(10) Pub. No.: US 2014/0089407 A1
(43) Pub. Date: Mar. 27, 2014

(54) LOCAL SOCIAL MOBILE NETWORK WITH ADVERTISING

(71) Applicant: Randy MERSKY, Silver Spring, MD (US)

(72) Inventor: Randy MERSKY, Silver Spring, MD (US)

(21) Appl. No.: 13/789,911

(22) Filed: Mar. 8, 2013

Related U.S. Application Data
(60) Provisional application No. 61/705,334, filed on Sep. 25, 2012.

(51) Int. Cl. H04W 4/02

(52) U.S. Cl. CPC H04W 4/02
USPC 709/204

(57) ABSTRACT

Systems, methods, and media for providing information exchange sessions are provided. A registration request is received from a first individual for registering for the information exchange session. The information exchange session is associated with a geographic location and has a predetermined timeframe. A virtual bulletin board of the first individual is activated during the predetermined timeframe. The virtual bulletin board of the first individual is deactivated at an end of the predetermined timeframe. The virtual bulletin board of the first individual is accessible during the predetermined timeframe and after activation via a network by at least one second individual that has registered for the information exchange session for exchanging information with the first individual.

### CROSS-REFERENCE TO RELATED APPLICATION

The present application claims the benefit of provisional application U.S. Pat. Appl. No. 61/705,334, filed on Sep. 25, 2012, the disclosure of which, including the specification and figures, is incorporated herein by reference in its entirety.

### BACKGROUND

1. Field of the Disclosure

The present disclose generally relates to the field of social networking. More particularly, the present disclosure relates to various systems, methods, and media for creating an electronic information exchange session.

2. Background Information

People today have greater access to electronic devices than ever before. They are able to access the electronic devices whether on the road, in the home, or in the office. This is something that could only previously be done from a permanently connected personal computer hooked to an appropriately provisioned network.

The increased access to electronic devices has resulted in ever increasing social networking platforms which enable people to communicate in an electronic universe. The people are able to share and express thoughts and ideas instantaneously, whether on the road, in the home, or in the office. In this regard, other people are allowed to access the shared and expressed ideas and thoughts instantaneously.

Both friends and strangers are being provided with ever increasing opportunities for electronic communication and interaction and an increasing amount of social networking platforms. Nevertheless, given the increasing access to electronic devices and the growing reliance on electronic communication and interaction, further social networking platforms and information exchange systems are desired.

### SUMMARY OF THE DISCLOSURE

The present disclosure, through one or more of its various aspects, embodiments, and/or specific features or sub-components, provides, inter alia, various systems, servers, methods, media, and programs for establishing information exchange sessions.

According to a non-limiting embodiment of the present disclosure, a server provides an information exchange session. The server includes a network interface, a processor, and a memory. The memory includes instructions that, when executed by the processor, cause the processor to execute operations. The operations include receiving, via a network and by the network interface, a registration request from a first individual for registering for the information exchange session. The information exchange session is associated with a geographic location and has a predetermined timeframe. The operations further include activating a virtual bulletin board of the first individual during the predetermined timeframe, and deactivating the virtual bulletin board of the first individual at an end of the predetermined timeframe. The virtual bulletin board of the first individual is accessible during the predetermined timeframe and after activation via a network by at least one second individual that has registered for the information exchange session for exchanging information with the first individual.

According to one aspect of the present disclosure, the information exchange session is further associated with an event that is at the geographic location during the predetermined timeframe.

According to another aspect of the present disclosure, the operations further include transmitting, via the network and by the network interface, unique activation information to the first individual after receiving the registration request. An activation request is received, via the network and by the network interface, from the first individual for joining the information exchange session during the predetermined timeframe. The activation request includes the unique activation information of the first individual. The server determines whether the unique activation information included in the activation request is valid, and the virtual bulletin board of the first individual is activated during the predetermined timeframe in response to receiving the activation request and determining that the unique activation information is valid.

According to yet another aspect of the present disclosure, the activation request includes the first individual executing a predetermined activity at the geographic location of the event for checking-in to the event.

According to still another aspect of the present disclosure, the first individual executes the predetermined activity with a mobile device. Moreover, the operations further include determining a geolocation of the mobile device when the first individual executes the predetermined activity with the mobile device to confirm a presence of the first individual at the geographic location of the event. In this regard, the virtual bulletin board of the first individual is activated during the predetermined timeframe only in response to confirming the presence of the first individual at the geographic location of the event.

According to an additional aspect of the present disclosure, the unique activation information that is transmitted to the first individual is a unique code, and the activation request that is received from the first individual includes the unique code.

According to another aspect of the present disclosure, the unique activation information that is transmitted to the first individual is included in a mobile application that is transmitted to the first individual, and the activation request of the first individual is received via the mobile application.

According to yet another aspect of the present disclosure, the activation request is automatically transmitted from the mobile application and received by the server when the mobile application is executed by the first individual.

According to still another aspect of the present disclosure, the operations further include determining a geolocation of the mobile device when the mobile application is executed by the first individual to confirm a presence of the mobile device at the geographic location of the event. In this regard, the virtual bulletin board of the first individual is activated during the predetermined timeframe only in response to confirming the presence of the mobile device at the geographic location of the event.

According to an additional aspect of the present disclosure, the operations further include receiving, via the network and by the network interface, a deactivation request from the first individual for deactivating the virtual bulletin board of the first individual before the end of the predetermined timeframe. The server deactivates the virtual bulletin board of the first individual before the end of the predetermined timeframe in response to receiving the deactivation request.

According to another aspect of the present disclosure, the first individual transmits the activation request with a mobile device. The operations further include monitoring a geolocation of the mobile device while the virtual bulletin board of the first individual is activated during the predetermined timeframe to determine whether the mobile device leaves the geographic location of the event. In this regard, the server automatically deactivates the virtual bulletin board of the first individual before the end of the predetermined timeframe in response to determining that the mobile device leaves the geographic location of the event.

According to yet another aspect of the present disclosure, the predetermined timeframe of the information exchange session corresponds to a timeframe of the event.

According to still another aspect of the present disclosure, the predetermined timeframe of the information exchange session is at most a timeframe of the event. The operations further include receiving, via the network and by the network interface, a payment from the first individual for extending the predetermined timeframe of the information exchange session, and extending the predetermined timeframe of the information exchange session in response to receiving the payment from the first individual for extending the predetermined timeframe of the information exchange session.

According to an additional aspect of the present disclosure, the operations further include receiving, via the network and by the network interface, an event registration request from an organizer of the event for registering the event for the information exchange session. The operations also include creating the information exchange session in response to the event registration request being received from the organizer of the event. The registration request from the first individual specifies the information exchange session.

According to another aspect of the present disclosure, the operations further include receiving, via the network and by the network interface, a payment from the organizer of the event in association with the event registration request from the organizer. The information exchange session is created only after receiving the payment in association with the event registration request.

According to yet another aspect of the present disclosure, the operations further include receiving, via the network and by the network interface, a template for the virtual bulletin board from the organizer of the event. The template includes information fields specified by the organizer of the event, and the first individual completes the information fields during a registration process.

According to still another aspect of the present disclosure, the virtual bulletin board of the first individual is configured to be broadcast on a display at the event.

According to yet another aspect of the present disclosure, the operations further include receiving, via the network and by the network interface, an opt-in request from the first individual for opting to broadcast the virtual bulletin of the first individual on the display at the event. In this regard, the virtual bulletin board of the first individual is broadcast on the display at the event only in response to the opt-in request being received from the first individual.

According to an additional aspect of the present disclosure, the operations further include receiving, via the network and by the network interface, a display payment from the first individual for broadcasting the virtual bulletin board of the first individual on the display at the event. The virtual bulletin board of the first individual is broadcast on the display at the event in response to the display payment being received from the first individual.

According to another aspect of the present disclosure, a list that identifies the first individual and the at least one second individual is configured to be broadcast on a display at the event.

According to yet another aspect of the present disclosure, the geographic location that is associated with the information exchange session corresponds to a venue from where the registration request is received from the first individual, and the at least one second individual registers for the information exchange session by submitting a second registration request from the venue from where the registration request is received from the first individual.

According to still another aspect of the present disclosure, the geographic location that is associated with the information exchange session corresponds to a position from where the registration request is received from the first individual, and the at least one second individual registers for the information exchange session by submitting a second registration request from within a predetermined distance of the position from where the registration request is received from the first individual.

According to yet another aspect of the present disclosure, the registration request includes personal information provided by the first individual.

According to an additional aspect of the present disclosure, the personal information provided by the first individual is anonymous about an identity of the individual and the virtual bulletin board of the first individual does not identify the identity of the first individual.

According to another non-limiting embodiment of the present disclosure, a method provides an information exchange session. The method includes receiving, via a network and by a network interface, a registration request from a first individual for registering for the information exchange session. The information exchange session is associated with a geographic location and has a predetermined timeframe. The method further includes activating, by a processor, a virtual bulletin board of the first individual during the predetermined timeframe, and deactivating, by the processor, the virtual bulletin board of the first individual at an end of the predetermined timeframe. The virtual bulletin board of the first individual is accessible during the predetermined timeframe and after activation via a network by at least one second individual that has registered for the information exchange session for exchanging information with the first individual.

According to an aspect of the present disclosure, the information session corresponds to an event that is at the geographic location.

According to another aspect of the present disclosure, the method further includes transmitting, via the network and by the network interface, unique activation information to the first individual after receiving the registration request. An activation request is received, via the network and by the network interface, from the first individual for joining the information exchange session during the predetermined timeframe. The activation request includes the unique activation information of the first individual. The method determines whether the unique activation information included in the activation request is valid, and the virtual bulletin board of the first individual is activated during the predetermined timeframe in response to receiving the activation request and determining that the unique activation information is valid.

According to yet another aspect of the present disclosure, the activation request includes the first individual executing a predetermined activity at the geographic location of the event for checking-in to the event.

According to still another aspect of the present disclosure, the first individual executes the predetermined activity with a mobile device. The method further includes determining a geolocation of the mobile device when the first individual executes the predetermined activity with the mobile device to confirm a presence of the first individual at the geographic location of the event. In this regard, the virtual bulletin board of the first individual is activated during the predetermined timeframe only in response to confirming the presence of the first individual at the geographic location of the event.

According to an additional aspect of the present disclosure, the unique activation information that is transmitted to the first individual via the network interface is a unique code, and the activation request that is received from the first individual via the network interface includes the unique code.

According to another aspect of the present disclosure, the unique activation information that is transmitted to the first individual is included in a mobile application that is transmitted to the first individual, and the activation request of the first individual is received via the mobile application.

According to yet another aspect of the present disclosure, the activation request is automatically transmitted from the mobile application and received by the server when the mobile application is executed by the first individual.

According to still another aspect of the present disclosure, the method further includes determining a geolocation of the mobile device when the mobile application is executed by the first individual to confirm a presence of the mobile device at the geographic location of the event. In this regard, the virtual bulletin board of the first individual is activated during the predetermined timeframe only in response to confirming the presence of the mobile device at the geographic location of the event.

According to yet another non-limiting embodiment of the present disclosure, a non-transitory computer readable medium includes an executable set of instructions for providing an information exchange session. The executable set of instructions, when executed by a processor, cause the processor to execute operations including receiving a registration request from a first individual for registering for the information exchange session. The information exchange session being associated with a geographic location and having a predetermined timeframe. A virtual bulletin board of the first individual is activated during the predetermined timeframe, and the virtual bulletin board of the first individual is deactivated at an end of the predetermined timeframe. The virtual bulletin board of the first individual is accessible during the predetermined timeframe and after activation via a network by at least one second individual that has registered for the information exchange session for exchanging information with the first individual.

According to an aspect of the present disclosure, the information session corresponds to an event that is at the geographic location.

According to another aspect of the present disclosure, the operations further include transmitting unique activation information to the first individual after receiving the registration request. An activation request is received from the first individual for joining the information exchange session during the predetermined timeframe. The activation request includes the unique activation information of the first individual. It is determined whether the unique activation information included in the activation request is valid, and the virtual bulletin board of the first individual is activated during the predetermined timeframe in response to receiving the activation request and determining that the unique activation information is valid.

According to yet another aspect of the present disclosure, the activation request includes the first individual executing a predetermined activity at the geographic location of the event for checking-in to the event.

According to still another aspect of the present disclosure, the first individual executes the predetermined activity with a mobile device. The operations further include determining a geolocation of the mobile device when the first individual executes the predetermined activity with the mobile device to confirm a presence of the first individual at the geographic location of the event. In this regard, the virtual bulletin board of the first individual is activated during the predetermined timeframe only in response to confirming the presence of the first individual at the geographic location of the event.

According to an additional aspect of the present disclosure, the unique activation information that is transmitted to the first individual is a unique code, and the activation request that is received from the first individual includes the unique code.

According to still another aspect of the present disclosure, the unique activation information that is transmitted to the first individual is included in a mobile application that is transmitted to the first individual, and the activation request of the first individual is received via the mobile application.

According to another aspect of the present disclosure, the activation request is automatically transmitted from the mobile application and received by the server when the mobile application is executed by the first individual.

According to yet another aspect of the present disclosure, the operations further include determining a geolocation of the mobile device when the mobile application is executed by the first individual to confirm a presence of the mobile device at the geographic location of the event. In this regard, the virtual bulletin board of the first individual is activated during the predetermined timeframe only in response to confirming the presence of the mobile device at the geographic location of the event.

### BRIEF DESCRIPTION OF THE DRAWINGS

The present invention is further described in the detailed description which follows, in reference to the noted plurality of drawings, by way of non-limiting examples of preferred embodiments of the present invention, in which like characters represent like elements throughout the several views of the drawings.

FIG. 1 illustrates an exemplary system for providing an information exchange session.

FIG. 2 illustrates an exemplary schematic of a system for providing an information exchange session.

FIG. 3 illustrates an exemplary information exchange session.

FIG. 4 illustrates an exemplary schematic of operations for providing an information exchange session.

FIGS. 5A-E illustrate exemplary schematics of a process for providing an information exchange session.

FIG. 6 illustrates exemplary schematic of a system for providing information exchange sessions.

FIG. 7 illustrates a partial schematic of a method for providing an information exchange session

FIG. 8 illustrates a partial schematic of a method for providing an information exchange session.

### DETAILED DESCRIPTION

The present disclosure, through one or more of its various aspects, embodiments and/or specific features or sub-components, is thus intended to bring out one or more of the advantages as specifically noted below.

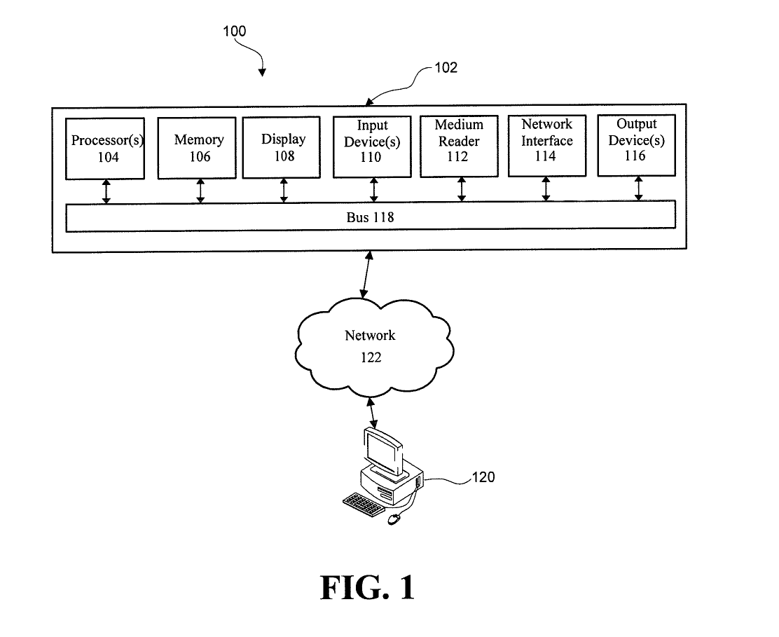

FIG. 1 is an exemplary system for use in accordance with the embodiments described herein. The system 100 is generally shown and may include a computer system 102, which is generally indicated. The computer system 102 may operate as a standalone device or may be connected to other systems or peripheral devices. For example, the computer system 102 may include, or be included within, any one or more computers, servers, systems, communication networks or cloud environment.

The computer system 102 may operate in the capacity of a server in a network environment, or the in the capacity of a client user computer in the network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that device. Further, while a single computer system 102 is illustrated, addition embodiments may include any collection of systems or sub-systems that individually or jointly execute instructions or perform functions.

As illustrated in FIG. 1, the computer system 102 may include at least one processor 104, such as, for example, a central processing unit, a graphics processing unit, or both. The computer system 102 may also include a computer memory 106. The computer memory 106 may include a static memory, a dynamic memory, or both. The computer memory 106 may additionally or alternatively include a hard disk, random access memory, a cache, or any combination thereof. Of course, those skilled in the art appreciate that the computer memory 106 may comprise any combination of known memories or a single storage.

As shown in FIG. 1, the computer system 102 may include a computer display 108, such as a liquid crystal display, an organic light emitting diode, a flat panel display, a solid state display, a cathode ray tube, a plasma display, or any other known display.

The computer system 102 may include at least one computer input device 110, such as a keyboard, a remote control device having a wireless keypad, a microphone coupled to a speech recognition engine, a camera such as a video camera or still camera, a cursor control device, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 and a network interface 114. Furthermore, the computer system 102 may include any additional devices, components, parts, peripherals, hardware, software or any combination thereof which are commonly known and understood as being included with or within a computer system, such as, but not limited to, an output device 116. The output device 116 may be, but is not limited to, a speaker, an audio out, a video out, a remote control output, a printer, or any combination thereof.

Each of the components of the computer system 102 may be interconnected and communicate via a bus 118. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, or any other network commonly known and understood in the art. The network 122 is shown in FIG. 1 as a wireless network. However, those skilled in the art appreciate that the network 122 may also be a wired network.

The additional computer device 120 is shown in FIG. 1 as a personal computer. However, those skilled in the art appreciate that, in alternative embodiments of the present application, the device 120 may be a laptop computer, a tablet PC, a personal digital assistant, a mobile device, a palmtop computer, a desktop computer, a communications device, a wireless telephone, a personal trusted device, a web appliance, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

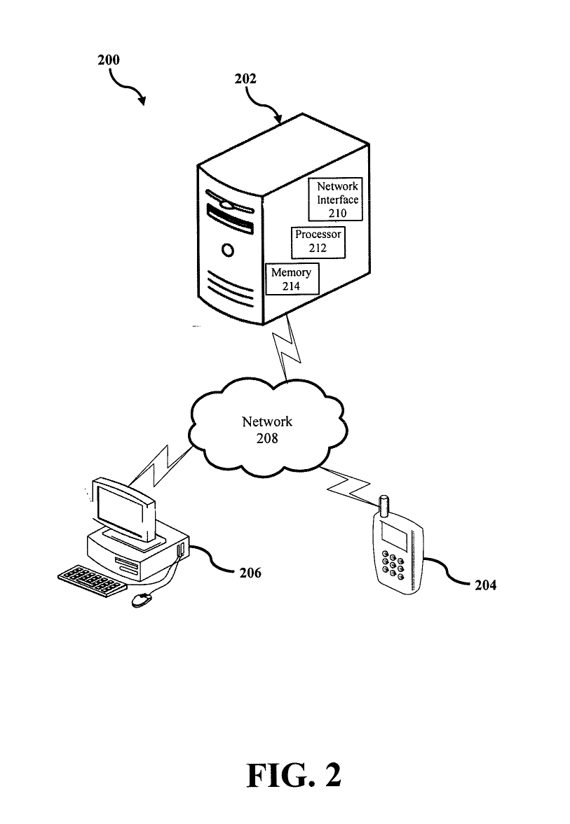

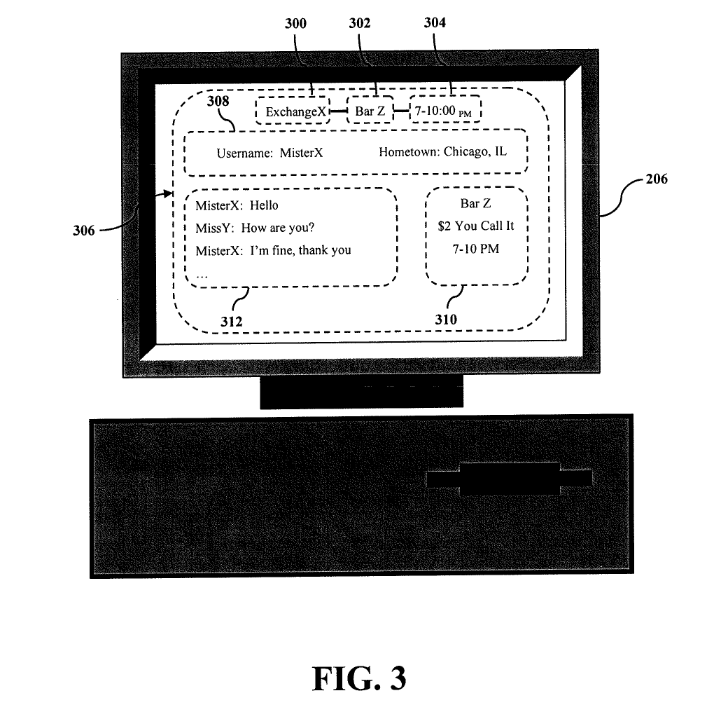

An exemplary schematic of a system for providing an information exchange session 300 is generally shown at 200 in FIG. 2. The system 200 is shown in FIG. 2 as including a server 202, a first electronic device 204, and a second electronic device 206. The server 202, the first electronic device 204, and the second electronic device 206 are interconnected via a network 208. An exemplary schematic of the information exchange session between the first electronic device 204 and the second electronic device 206 is shown at 300 in FIG. 3. The information exchange session 300 is shown as being displayed on the second electronic device 206. Nevertheless, those of ordinary skill in the art appreciate that the information exchange session 300 is also accessible via the first electronic device 204.

The first electronic device 204 of FIG. 2 is shown as being a cellular telephone, while the second electronic device 206 is shown as being a computer. These illustrations of the first electronic device 204 and the second electronic device 206 are merely exemplary and are not intended to be limiting. The first electronic device 204 and the second electronic device 206 may additionally or alternatively be any device which is capable of communicating with the server 202 via the network 208. For example, the first electronic device 204 and the second electronic device 206 may by similar to the computer system 102 or the one or more additional computer devices 102, as described with respect to FIG. 1, and comprise any of the non-limiting and exemplary devices discussed with respect thereto.

The network 208 is shown as being similar to the network 122 of FIG. 1. In this regard, the network 208 may include any of the non-limiting and exemplary networks discussed with respect to the network 122 of FIG. 1, and may additionally or alternatively include any other network that is known and understood in the art.

The system 200 of FIG. 2 provides the information exchange session 300 between the first electronic device 204 and the second electronic device 206. According to one non-limiting and exemplary advantageous effect of the system 200, the information exchange session 300 enables a first individual that uses the first electronic device 204 and a second individual that uses the second electronic device 206 to interact initially and comfortably in a local setting via the first electronic device 204 and the second electronic device 206. In this regard, the information exchange session 300 is associated with a geographic location 302 and has a predetermined timeframe 304. As a result, the first individual and the second individual, when both being registered and active participants in the information exchange session 300, are ensured of interacting in a local setting.

For example, according to a specific non-limiting and exemplary embodiment, the information exchange session 300 may be associated with a business conference that is being held at a specific auditorium during a specific timeframe. The first individual and the second individual may each register for the information exchange session 300 of the business conference, which is associated with the specific auditorium at which the business conference is to be held and the specific timeframe during which the business conference is to be held. The first individual and the second individual may each be required to activate their respective registrations for the information exchange session 300 by checking-in to the business conference. Thereafter, the first individual and the second individual may interact via the information exchange session 300 while being ensured of being in a same proximity at a same time, e.g., at the specific auditorium during the specific timeframe of the business conference.

According to a further non-limiting and exemplary embodiment of the present application, the system 200 may allow the first individual and the second individual to interact via the information exchange session 300 anonymously. For example, the first individual and the second individual may interact as strangers without having to provide phone numbers, email addresses, etc. In this regard, the system 200 further provides an additional non-limiting and advantageous effect of enabling strangers to interact comfortably and without embarrassment in a local setting via electronic devices. The electronic devices may further be mobile devices for further maintaining anonymity.

For example, according to another specific non-limiting and exemplary embodiment, the information exchange session 300 may be associated with a singles mixer that is being held at a specific bar during a specific timeframe. The first individual and the second individual may each register for the information exchange session 300 of the singles mixer, which is associated with the specific bar at which the singles mixer is to be held and the specific timeframe during which the singles mixer is to be held. The first individual and the second individual may again activate their respective registrations by checking-in to the singles mixer. Thereafter, the first individual and the second individual may interact via the information exchange session 300 while being ensured of being in a same proximity at a same time, e.g., at the specific bar during the specific timeframe of the singles mixer. Moreover, provided that the information exchange session 300 is anonymous as to an identity of the first individual and an identity of the second individual, the first individual and the second individual may interact freely and comfortably without embarrassment. For example, the first individual and the second individual may express or indicate their true wants or intentions via the information exchange session 300 without having to be held personally accountable. As a result, the first individual and the second individual may be better able to determine a level of correspondence or compatibility before meeting face-to-face at the singles mixer.

The above-described examples, embodiments, and effects are merely exemplary and provided for illustrative purposes. The examples, embodiments, and effects are not to be considered limiting or exhaustive. Additional examples, embodiments, and effects are further described below, and even further examples, embodiments, and effects should become apparent from the present application when considered in its entirety.

In an embodiment of the present application as shown in FIG. 2, the server 202 includes a network interface 210 for sending and receiving communications via the network 208. The network interface 210 may be, for example, similar to the network interface 114 as described with respect to FIG. 1.

The server 202 further includes a processor 212 and a memory 214. The processor 212 may be a single processing unit, or comprise a plurality of processing units. For example, the processor 212 may include a distinct central processing unit and a distinct graphics processing unit. Similarly, the memory 214 may be a single memory unit, or comprise a plurality of memory units. For example, the memory 214 may include various combinations of a hard disk, a random access memory module, a cache, and an optical disk. In this regard, the processor 212 and the memory 214 may be similar to, for example, the processor 104 and the memory 106 as described with respect to FIG. 1. Of course, the above-mentioned examples are merely meant to be exemplary and are not to be limiting.

The server 202 is shown in FIG. 2 as including only the network interface 210, the processor 212, and the memory 214. Nevertheless, those of ordinary skill in the art understand that the server 202 is not limited to including only the network interface 210, the processor 212, and the memory 214. For example, in further embodiments of the present application, the server 202 may by similar to the computer system 102, as described with respect to FIG. 1. In this regard, the server 202 may include any combination of the components or features of the computer system 102, as described with respect to FIG. 1. For example, the server 202 may include a graphics display, similar to the display 108 of FIG. 1. Moreover, those of ordinary skill in the art appreciate that the server 202 is not limited to including only those components and features of the computer system 102 and that the server 202 may additionally or alternatively include any server components or features which are known and understood in the art.

The server 202 is shown in FIG. 2 as being an integrated system. Nevertheless, in further embodiments of the present application, the server 202 may comprise a component or distributed system. In this regard, the features and/or components of the server 202 may be locally distributed, or the features and/or components may be distributed across a network. The features and/or components of the server 202 may be controlled or managed by a single entity, or control and management of the features and/or components of the server 202 may be distributed amongst multiple entities. For example, the memory 214 may be managed by a “cloud” storage provider.

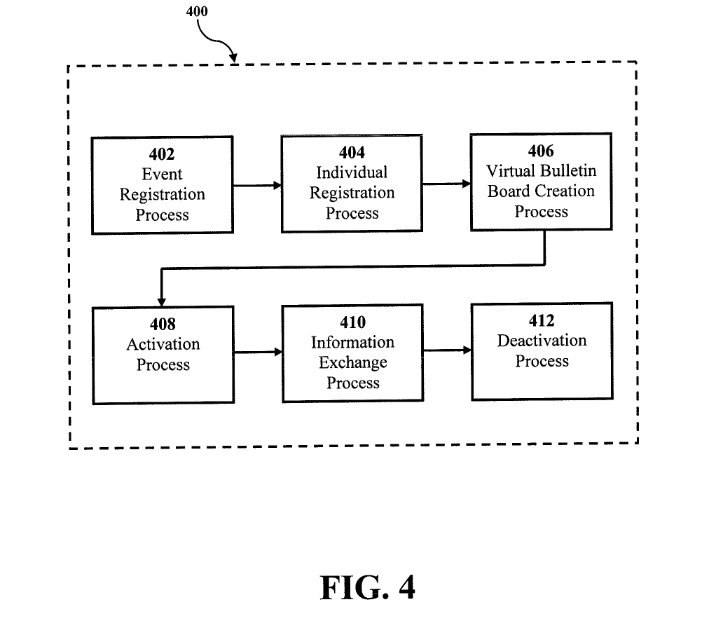

According to an embodiment of the present application, the memory 214 of the server 202 includes executable instructions that, when executed by the processor 212, cause the processor 212 to execute operations. The operations involve the creation, execution, and termination of the information exchange session 300. A schematic of an exemplary combination of operations by which the server 202 creates, executes, and terminates the information exchange session 300 is generally indicated in FIG. 4 at 400. The exemplary combination of operations 400 is shown in FIG. 4 as including various processes 402-412. Those of ordinary skill in the art understand that the processes 402-412 are merely exemplary and are not limiting, exhaustive, or exclusive. Each of the processes 402-412 may comprise a single operation or include a plurality of operations. Moreover, the various operations involved in the creation, execution, and termination of the information exchange session 300 are not limited to being included in any single one of the processes 402-412 of FIG. 4. Each of the operations may span multiple ones of the processes 402-412 and/or be included in additional or alternative ones of the processes 402-412.

The combination of operations 400 of FIG. 4 includes an event registration process 402, an individual registration process 404, a virtual bulletin board creation process 406, an activation process 408, an information exchange process 410, and a virtual bulletin board deactivation process 412. Once again, these processes 402-412 are merely exemplary and are not limiting, exhaustive, or exclusive. Additional embodiments of the present application may include additional or alternative processes and combinations thereof.

During the event registration process 402, the server 202 receives a request for a registration of the information exchange session 300. The request may be received by the network interface 210 of the server 202 via the network 208. In embodiments of the present application in which the information exchange session 300 corresponds to an event, such as the business conference or the singles mixer, the request may be received from an organizer, producer, or host of the event. According to such embodiments, the organizer, producer, or host of the event may access a website of the server 202, and submit an event registration request. The website is a network operator system that enables and maintains the information exchange session 300.

According to embodiments of the present application, the server 202 receives the event registration request from the organizer, producer, or host of the event, and creates the information exchange session 300 in response to receiving the event registration request. According to further embodiments of the present application, the server 202 requires that a payment be submitted prior to creating the information exchange session 300. In this regard, the server 202 may create the information exchange session 300 only after receiving the payment from the organizer, producer, or host of the event. Moreover, in even further embodiments, the server 202 may require that a fee additionally or alternatively be paid by the geographic location 302 to which the information exchange session 300 corresponds.

The payment may be a predetermined or fixed fee. Alternatively, the payment may be dependent upon the event to which the information exchange session 300 is associated. For example, the payment may be dependent upon a size or a maximum number of eligible participants of the information exchange session 300. The payment may additionally or alternatively be dependent upon the geographic location 302 or the predetermined timeframe 304 of the information exchange session 300. In even further additional or alternative embodiments, the payment may correspond to an ability for displaying advertisements on virtual bulletin boards of participants of the information exchange session 300. For example, in the above-described exemplary embodiment in which the information exchange session 300 is associated with the singles mixer at the specific bar, the organizer, producer, or host of the singles mixer may pay an additional or increased payment for displaying advertisements or specials of the specific bar on the virtual bulletin boards of the participants of the information exchange session 300. An exemplary virtual bulletin board is generally shown in FIG. 3 at 306, and is described in more detail below. An exemplary advertisement is generally shown in FIG. 3 at 308. Of course, those of ordinary skill in the art appreciate that the above described examples of payment dependency are merely exemplary and that the payment may be determined in accordance with any known procedures or methods. Moreover, the payment is described herein as being associated with an event to which the information exchange session 300 corresponds. Nevertheless, those of ordinary skill in the art appreciate that the payment may also be required for and correspond to an information exchange session 300 which is not associated with an event.

After the information exchange session 300 is registered with the server 202, the first individual may access the website of the server 202 via the network 208 during the individual registration process 404. The first individual may access the website with the first electronic device 204 from which the first individual intends to participate in the information exchange session 300. Alternatively, the first individual may access the website via any network-accessible electronic device, and thereafter participate in the information exchange session 300 via the first electronic device 204. In other words, in embodiments of the present application, registration and participation in the information exchange session 300 need not be limited to being performed with a single electronic device. Nevertheless, in further embodiments of the present application as discussed in more detail herein, registration and participation in the information exchange session 300 may be limited to being performed with a single electronic device.

The server 202 receives a registration request from the first individual for registering for the information exchange session 300. The registration request may be received from the first electronic device 204, or from any other network-accessible electronic device of the first individual, via the network 208. The network interface 210 of the server 202 may receive the registration request for the information exchange session 300.

The information exchange session 300 for which the first individual would like to register is associated with the geographic location 302 and has the predetermined timeframe 304. For example, in the above-described exemplary embodiment in which the information exchange session 300 is the business conference, the information exchange session 300 is associated with the specific auditorium in which the business conference is to be held and the specific timeframe during which the business conference is to be held. In further exemplary embodiments, the geographic location 302 may be any activity, place, or area. For example, the geographic location 302 may be a location of a rally or protest, the venue or park at which a concert is to be performed, an area of a city, a building, etc. Of course, these examples are merely exemplary and are not limiting or exhaustive.

The predetermined timeframe 304 may be any timeframe of a set or specific period or duration. In this regard, the predetermined timeframe 304 may be set or specified in terms of any known measure of time such as, but not limited to, months, weeks, days, hours, minutes, etc. The predetermined timeframe 304 may be defined as including a predetermined range of time from a starting time point to an ending time point, such as from 10:00 pm to 11:00 pm on Jan. 1, 2014. Alternatively, the predetermined timeframe 304 may be defined as including only an ending time point, such as 11:00 pm on Jan. 1, 2014. According to such an embodiment, the predetermined timeframe 304 is defined as being from a present time point to the ending time point. Once again, those of ordinary skill in the art understand that the above-listed example are merely exemplary and are not limiting or exhaustive.

The predetermined timeframe 304 may also correspond to an event and need not correspond to a specific or definite time period. In this regard, the predetermined timeframe 304 may vary by the specific event type. That is, the predetermined timeframe 304 may be several days for a convention, while the predetermined timeframe 304 may only be one day for a meet and greet. Moreover, the predetermined timeframe 304 may also correspond to events that have unknown durations, such as a sporting event. According to such an example, the predetermined timeframe 304 is indefinite, albeit, nonetheless predetermined.

According to embodiments of the present application, as generally described above with respect to the business conference and the singles mixer, the information exchange session 300 may be further associated with an event that is at the geographic location 302 during the predetermined timeframe 304. The information exchange session 300 is generally described hereinafter as being further associated with an event for convenience. Nevertheless, those of ordinary skill in the art understand that the information exchange session 300 need not be associated with an event in further embodiments of the present application.

The registration request may specify, identify, or indicate the information exchange session 300 for which the first individual would like to register. For example, the registration request may specify, identify, or indicate the information exchange session 300 upon the first individual selecting the information exchange session 300 from a list of information exchange sessions displayed on the website. Additionally or alternatively, the registration request may specify, identify, or indicate the information exchange session 300 upon the first individual finding or locating the information exchange session 300 in a database of information exchange sessions which are searchable via the website. In this regard, the information exchange sessions may be publicly accessible or privately accessible. For example, select ones of the information exchange sessions may be accessible to only specific individuals that satisfy a certain criteria such as, but not limited to, belonging to an association or membership club, paying a fee, including a profile of a specific nature, etc. The server 202 may store and/or support an unlimited number of information exchange sessions at any given time. Alternatively, the server 202 may store and/or support a predetermined maximum number of information exchange sessions at any given time.

The first individual may select, find, or locate the information exchange session 300 based on keyword searching, field selection, or any combination thereof. The first individual may keyword search or select a field based on the geographic location 302 of the information exchange session 300, the predetermined timeframe 304 of the information exchange session 300, the event or activity that is associated with the information exchange session 300, or any combination thereof. Of course, those of ordinary skill in the art understand that the above-described methods for specifying, identifying, or indicating the information exchange session 300 are merely exemplary and are not limiting or exhaustive. Additional or alternative methods for specifying, identifying, or indicating the information exchange session 300 may be used without departing from the scope of the present application.

The first individual may provide personal information during the individual registration process 404, either before, with, or after the registration request. The personal information is generally shown in FIG. 3 at 310. The personal information 310 may include a username of the first individual (which may be anonymous with respect to the actual identity of the first individual). The personal information 310 may also comprise a profile of the first individual. In this regard, the profile may be completed or provided by the first individual with or after the registration request, or the profile may be provided via log-in information of the first individual. That is, the first individual may log-in to the website, whereby a stored profile of the first individual is accessed by the server 202.

The profile of the first individual may comprise past information which was previously provided by the first individual, review information which was previously provided by other individuals about the first individual, history information which includes a history of past information exchange sessions for which the first individual registered and/or participated in, or any combination thereof. The personal information 310 of the individual may include text-based information, photographs, images, or any combination thereof. Those of ordinary skill in the art appreciate that the personal information 310 of the first individual may include any information which is known and understood in the art.

In the above described embodiments, the personal information 310 is described as possibly including information provided by other individuals. However, in further embodiments of the present application, the personal information 310 of the first individual may be limited to including only information which is volunteered by the first individual. According to such embodiments, the first individual may provide limited personal information which is anonymous as to an identity of the first individual. As a result, the first individual may interact comfortably and without embarrassment in the geographic location 302 during the predetermined timeframe 304 via the information exchange session 300. For example, in the previously described embodiment in which the information exchange session 300 is associated with the singles mixer, the first individual may interact comfortably and without embarrassment during the singles mixer via the information exchange session 300.

In even further embodiments of the present application, the first individual may be required to complete a questionnaire that is associated with the information exchange session 300. The questionnaire may include various information fields which are related to the information exchange session 300. The first individual may be required to answer or complete the information fields of the questionnaire either before or concurrently with a submission of the registration request.

The questionnaire may be generic to all information exchange sessions, or the questionnaire may be specific to the information exchange session 300 for which the first individual submits the registration request. For example, in the above-described embodiment in which the information exchange session 300 corresponds to the singles mixer, the questionnaire may include check-boxes that suggest availability, type and age of person they want to meet, income, etc. In the above-described embodiment in which the information exchange session 300 corresponds to the business convention, the questionnaire may include other check-boxes such as size of company, job title, etc. These examples are, of course, non-limiting and exemplary.

In embodiments of the present application in which the questionnaire is specific to the information exchange session 300, the questionnaire may be provided by an organizer, producer, or host of the event to which the information exchange session 300 is associated. In this regard, the questionnaire may be received by the server 202 from the organizer, producer, or host of the event during the event registration process 402. According to such an embodiment, the network interface 210 of the server 202 may receive the questionnaire from the organizer, producer, or host of the event via the network 208. The server 202 may require that a payment be received from the organizer, producer, or host of the event in conjunction with the questionnaire. In further embodiments, the server 202 may create the questionnaire to coincide with the particular event, the geographic location 302, and/or the predetermined timeframe 304 to which the information exchange session 300 is associated.

The server 202 may require that a payment be received from the first individual for completion of the individual registration process 404. The payment may be a predetermined or fixed fee. Alternatively, the payment may be dependent upon the event to which the information exchange session 300 is associated. For example, the payment may be dependent upon a size or a maximum number of eligible participants for the information exchange session 300. The payment may additionally or alternatively be dependent upon the geographic location 302 or the predetermined timeframe 304 of the information exchange session 300. In even further additional or alternative embodiments, the payment may correspond to an ability for displaying advertisements on virtual bulletin boards of participants of the information exchange session 300. For example, in the above-described exemplary embodiment in which the information exchange session 300 is associated with the singles mixer at the specific bar, the first individual may submit a payment such that the first individual is promoted or advertised on other participants' virtual bulletin boards as being a desirable or high-quality character.

Upon submission of the registration request and completion of the individual registration process 404, the server 202 creates the virtual bulletin board 306 for the first individual for the information exchange session 300. The virtual bulletin board creation process 406 is described herein and shown in FIG. 4 as being after the individual registration process 404. Nevertheless, those of ordinary skill in the art understand that the virtual bulletin board creation process 406 may be before, during, or after the individual registration process 404 in further embodiments of the present application. Along, these lines the virtual bulletin board creation process 406 is also described herein and shown as being before the activation process 408. Nevertheless, those of ordinary skill in the art should also appreciate that the virtual bulletin board creation process 406 is not limited to being before the activation process 408 or any of the other processes 410-412 of FIG. 4. The virtual bulletin board creation process 406 may further be executed by the server 202 during or after the activation process 408 or any of the other processes 410-412 of FIG. 4. In this regard, the processes 402-412 of FIG. 4 are not to be interpreted as being order-dependent and may be performed simultaneously or in any order in further embodiments of the present application.

During the virtual bulletin board creation process 406, the server 202 creates the virtual bulletin board 306 for the first individual for use in the information exchange session 300, and may further enable the first individual to edit the virtual bulletin board 306. In other words, the virtual bulletin board creation process 406 may include both the creation and editing of the virtual bulletin board 306 of the first individual. In this regard, the first individual is able to customize and personalize his or her virtual bulletin board 306. In certain embodiments of the present application, however, the virtual bulletin board creation process 406 only includes the creation of the virtual bulletin board 306 of the first individual, whereby the first individual is not permitted to customize or personalize his or her virtual bulletin board 306.

The virtual bulletin board 306 may be newly created by the server 202 for the first individual for the information exchange session 300. The virtual bulletin board 306 may be created in correspondence with a virtual bulletin board template that is associated with the information exchange session 300. The virtual bulletin board template may correspond to the questionnaire that is associated with the information exchange session 300 and that is completed by the first individual during the individual registration process 404. In this regard, the virtual bulletin board template may be received by the server 202 from the organizer, producer, or host of the event. According to such an embodiment, the network interface 210 of the server 202 may receive the virtual bulletin board template from the organizer, producer, or host of the event via the network 208. The server 202 may require that a payment be received from the organizer, producer, or host of the event in conjunction with the virtual bulletin board template. In further embodiments, the server 202 may create the virtual bulletin board template to coincide with the questionnaire or to coincide with the event, the geographic location 302, and/or the predetermined timeframe 304 to which the information exchange session 300 is associated.

In correspondence with the above-described examples regarding the questionnaire, when the information exchange session 300 corresponds to the singles mixer, the virtual bulletin board template may include check-boxes that suggest availability, type and age of person they want to meet, income, etc. When the information exchange session 300 corresponds to the business convention, the virtual bulletin board template may include other check-boxes such as size of company, job title, etc. Of course, these examples are again non-limiting and exemplary.

In further embodiments of the present application, the server 202 may create the virtual bulletin board 306 of the first individual in correspondence with a default virtual bulletin board of the first individual or a previously used virtual bulletin board of the first individual that was used by the first individual in a previous information exchange session. The above described embodiments for creating the virtual bulletin board 306 are merely exemplary and are not limiting or exhaustive. Those of ordinary skill in the art appreciate that other known methods may also be used for creating the virtual bulletin board 306 by the server 202. For example, the server 202 may create the virtual bulletin board 306 of the first individual in correspondence with a selection of a sample virtual bulletin board made by the first individual from among a plurality of sample virtual bulletin boards.

The virtual bulletin board 306 of the first individual may include any of the personal information 310 of the first individual as discussed above. For example, the virtual bulletin board 306 may include the username of the first individual, the profile information, or any combination thereof. The virtual bulletin board 306 may additionally or alternatively include any further information which is selected by the first user from the website or which is uploaded by the first user to the website. In certain embodiments of the present application, the virtual bulletin board 306 of the first user may even be editable or customizable by other individuals. The virtual bulletin board 306 of the first individual may identify the identity of the first individual. In alternative embodiments, the virtual bulletin board 306 of the first individual does not identify the identity of the first individual.

After the virtual bulletin board 306 is created and customized, if customizable, the server 202 may close the virtual bulletin board 306 from further editing and customizing. Alternatively, the server 202 may allow the virtual bulletin board 306 to remain open for further editing and customizing. In embodiments of the present application, the virtual bulletin board 306 may be editable and customizable during any combination of processes 408-412 of FIG. 4. For example, the virtual bulletin board 306 of the first individual may be editable during processes 408-410 of FIG. 4 until the virtual bulletin board 306 is deactivated during the deactivation process 412 of FIG. 4.

In even further embodiments of the present application, the server 202 may allow or disallow further editing and customizing, including deletion, of the virtual bulletin board 306 of the first individual based on a permission setting of the first individual. The permission setting of the first individual may be associated with the profile of the first individual. Additionally, or alternatively, the permission setting of the first individual may be indicated by an unique identification information that is transmitted by the server 202 to the first individual during the activation process 408, which is described in more detail below. The server 202 may set the permission setting of the first individual based on or in correspondence with a payment that is received from the first individual. The permission setting may indicate a maximum number of edits, a timing of edits, and/or a level of edits depending on an amount of the payment. The level of edits may include, for example, a first level of edits for edits to the personal information 310 of the first individual and a second level of edits for edits to an information exchange 312 of the first individual during the information exchange session 300. The information exchange 312 is generally shown in FIG. 3 at 312.

In further embodiments of the present application, the server 202 may set the permission setting of the first individual based on or in correspondence with an opt-in request for advertisements that is received by the server 202 from the first individual. The opt-in request for the advertisements may include or correspond to a level or amount of advertisements which are permitted to be displayed on the virtual bulletin board 306 of the first individual. For example, the more advertisements that the first individual allows to be displayed, the more freely that the first individual is allowed to edit the virtual bulletin board 306.

Upon completion of the individual registration process 404 and/or the virtual bulletin board creation process 406, the server 202 may transmit unique activation information to the first individual during the activation process 408. The network interface 210 of the server 202 may transmit the unique activation information to the first individual via the network 208. The unique activation information is valid for activating the virtual bulletin board 306 of the first individual during the predetermined timeframe 304 for enabling the first individual to participate in the information exchange session 300.

According to an embodiment of the present application, features of the unique identification information may be set by the server 202. For example, the unique activation information may be set so as to be valid for a limited time period. A length of the limited time period may be set in accordance with a payment which is received from the first individual. The limited time period during which the unique activation information is set to be valid may correspond to the predetermined timeframe 304 of the event. In this regard, the limited time period may be equal to the predetermined timeframe 304. Alternatively, the limited time period frame may be set so as to start a predetermined time after the starting time point of the predetermined timeframe 304, and/or to end a predetermined time before the ending time point of the predetermined timeframe 304. Of course, those of ordinary skill in the art understand that the above-mentioned examples are merely exemplary and are not limiting or exhaustive. Those of ordinary skill in the art understand that the server 202 may also set the limited time period of the unique activation information in accordance with additional methods without departing from the scope of the present application.

For example, the server 202 may assign a registration time period to the first individual during which the individual is able to register for the event. The limited time period during which the unique activation information is set to be valid may be set to correspond to the registration time period. In this regard, according to an embodiment of the present application, the registration time period which is assigned to the first individual may correspond to a payment which is received from the first individual. An amount of the payment may increase with more desirable time periods. The more desirable time periods may include, but are not limited to, earlier time periods with respect to a timing of the event or time periods which correspond to a certain time of day. The more desirable time periods may also include time periods which correspond to a certain stage or point of the event, such as, for example, a time of a notable speaker when the event is the business conference or a time of a main performer when the event is of the performing arts.

After receiving the unique activation information from the server 202, the first individual transmits an activation request to the server 202 for joining the information exchange session 300 during the predetermined timeframe. The activation request includes the unique activation information. The server 202 receives the activation request from the first individual and determines whether the unique activation information is valid. In this regard, the server 202 activates the virtual bulletin board 306 of the first individual during the predetermined timeframe 304 in response to receiving the activation request and determining that the unique activation information is valid.

According to an embodiment of the present application, the unique activation information may be a unique code that is transmitted to the first individual. According to such an embodiment, the activation request that is received by the server 202 from the first individual includes the unique code. The first individual may transmit the unique code to the server 202 from any electronic device, including those devices which are different from a device with which the first individual completed the individual registration process 404 and/or the virtual bulletin board creation process 406. This provides the first user with the freedom to use different electronic devices when registering for the information exchange session 300, creating the virtual bulletin board 306, and/or participating in the information exchange session 300.

According to another embodiment of the present application, the unique activation information may comprise, or be embedded within, a mobile application. In this regard, the first individual may choose to download the mobile application during the individual registration process 404 or the virtual bulletin board creation process 406. If the first individual chooses to download the mobile application, the first individual may not need to manually provide the activation request or a unique code when setting up his or her virtual bulletin board 306 or when activating his or her virtual bulletin board 306. Instead, the mobile application may know an identity of the first individual and may have an internally stored key or link to the first individual's profile or the virtual bulletin board 306 of the first individual for the information exchange session 300. As a result, when the first individual executes, runs, or installs the mobile application, the mobile application may automatically validate the first individual or automatically transmit the activation request to the server 202.

According to an embodiment of the present application, the activation process 408 may include the first individual executing a predetermined activity at the geographic location 302 of the event for checking-in to the event. The predetermined activity may be executed in conjunction with the activation request, or be executed independently of the activation request. For example, the first individual that has registered for the information exchange session 300 may go to the particular geographic location 302 that is associated with the information exchange session 300. The geographic location 302 may be a bar, nightclub, singles club, convention, etc. which is hosting an event that has enrolled to participate in the information exchange session 300. The first individual may be required to physically check-in to the geographic location 302 of the event, via the first individual's presence at the geographic location 302.

The first individual may physically check-in to the event by providing information to the event or by receiving information from the event. For example, the first individual may be required to provide the unique activation information for entry to the event. As another example, the first individual may be required to obtain information from the event, such as a uniform resource locator, for checking-in to the event. The first individual may also check-in to the information exchange session 300 by scanning a QR code at the geographic location 302 of the event, and thereafter providing the unique activation information to the server 202. In even further embodiments, the first individual may check-in to the event in additional or alternative manners, such as by receiving a location presence confirmation. In any event, the first individual may be required to provide information at the geographic location 302 of the event, receive information at the geographic location 302 of the event, or perform some other predetermined activity at the geographic location 302 of the event as a part of or in addition to the act of transmitting the activation request to the server 202 in order to ensure that the first individual is physically located at the geographic location 302 of the event.

In embodiments of the present application, the server 202 activates the virtual bulletin board 306 of the first individual only in response to receiving the activation request, determining that the unique activation information is valid, and confirming the presence of the first individual at the geographic location 302. Such features ensure that only physically present individuals participate in the information exchange session 300 and prevent leechers from participating in the information exchange session 300. The above-mentioned procedures by which the first individual must be physically present at the geographic location 302 of the event for checking-in to the event are merely exemplary, and those of ordinary skill in the art understand that additional procedures may also be used without departing from the scope of the present application.

According to additional embodiments of the present application, additionally or alternatively to the above-mentioned procedures for confirming the physical presence of the first individual at the geographic location 302 of the event, the server may actively monitor or determine the physical presence of the first individual at the geographic location 302. The server 202 may determine a location of the first individual by geotracking or geotagging, whereupon the server 202 is able to actively confirm the physical presence of the first individual at the geographic location 302 of the event.

If the first individual is using a mobile device, the server 202 may determine a geolocation of the mobile device during the activation process 408 to confirm that the first individual is physically located at the geographic location 302 of the event. In this regard, the server 202 might activate the virtual bulletin board 306 of the first individual only in response to receiving the activation request, determining that the unique activation information is valid, and confirming the presence of the first individual at the geographic location 302 of the event via the geolocation. According to such an embodiment, the server 202 is able to confirm, or doubly confirm, that the first individual is at the geographic location 302 of the event to ensure that only physically present individuals participate in the information exchange session 300.

Upon completion of the activation process 408, the server 202 activates the virtual bulletin board 306 of the first individual during the predetermined timeframe 304. Moreover, as additional individuals check-in to the information exchange session 300 using their own unique activation information, their respective virtual bulletin boards become active as well. The limited time duration, e.g., temporary, virtual bulletin board of the first individual and virtual bulletin boards of the additional individuals are now accessible and viewable by any individual that has checked in to the information exchange session 300 during the information exchange process 410.

During the information exchange process 410, the first individual and the additional individuals are each able to view the virtual bulletin boards of all participating individuals, and to view any information contained therein. According to a further embodiment, the first individual, or any of the additional individuals, may set criteria by which the additional individuals are able to view the virtual bulletin board 306. In this regard, all of the additional individuals which have checked-in to the message exchange session may not be able to view the virtual bulletin board 306 of the first individual, but rather, only those additional individuals which correspond to the set criteria of the first individual are able to view the virtual bulletin board 306 of the first individual. According to such an embodiment, the first individual may selectively determine which of the additional individuals are able to view his or her virtual bulletin board 306. For example, the first individual may selectively set criteria so that only those additional individuals which appeal to the first individual are able to view the virtual bulletin board 306 of the first individual.

According to another embodiment of the present application, the first individual, or any of the additional individuals, may be able to block specific ones of the additional individuals from viewing his or her virtual bulletin board 306. According to such an embodiment, the first individual may block undesirable individuals from viewing and/or posting on his or her virtual bulletin board 306. Along these lines, the first individual may entirely block a particular individual from viewing his or her virtual bulletin board 306. As such, the first individual may avoid any and all contact with that particular individual, even preventing the particular individual from being aware of the first individual's presence at the event. Alternatively, the first individual may merely block the particular individual from posting on his or her virtual bulletin board 306. As such, the particular individual is permitted to monitor communications of the first individual with other individuals, but is prevented from communicating with the first individual.

With regards to the above, a part of the virtual bulletin board 306 of the first individual may include a message or bulletin that indicates to others not to interact with him or her, or which indicates with whom he or she wants to interact. As an example, if the first individual does not want to communicate with any of the additional individuals, he or she may post a “do not disturb bulletin.” As an additional example, if a woman does not want to be approached by men, she may post a “men do not disturb bulletin.” Of course, additional bulletins or messages may be posted by an individual if he or she is only interested in interacting with a particular type of person.

In viewing the virtual bulletin boards, the individuals are able to freely send messages to one another. In this regard, the first individual may send a message to all additional individuals, or the first individual may send a message to any one of the additional individual, or group of the additional individuals, which is appealing. The degree of communication may remain as anonymous as the first individual and the additional individuals would like. For example, at a bar, flirting may go on without revealing any true personal information unless the parties would like for it to be exchanged.

In an embodiment of the present application, the venue or host of the event at the geographic location 302 may access the virtual bulletin board 304 of the first individual, or the virtual bulletin boards of the additional individuals, that is actively participating in the information exchange session 300. In further embodiments, the venue or host of the event at the geographic location 302 may even access the virtual bulletin board 304 of the first individual, or the virtual bulletin boards of the additional individuals, that is inactively participating in the information exchange session 300.

According to such embodiments, the venue or host of the event may access a list of the individuals that are actively and/or inactively participating in the information exchange session 300 from the server 202. The server 202 may provide the venue or host of the event with a host virtual bulletin board that is configured to display the list of individuals that are actively and/or inactively participating in the information exchange session 300. The venue or host of the event may display the host virtual bulletin board on a display screen at the event. The venue or host of the event may also be able to display advertisements on the host virtual bulletin board, which is displayable on the display screen at the event. In this regard, the server 202 may require that the venue or host of the event submit a payment for displaying the host virtual bulletin board 306 on the display screen. The server 202 may also require an additional payment for enabling the host virtual bulletin board to display the advertisements. Nevertheless, the venue or host is able to promote each of the information exchange session 300, the event, the geographic location, and the individuals which are actively and/or inactively participating in the event via the host virtual bulletin board.

According to an embodiment of the present application, the host virtual bulletin board may also be configured to broadcast the virtual bulletin board 306 of the first individual, or any profile information of the first individual, at the event. According to such an embodiment, the first individual may receive additional promotion or exposure of himself or herself at the event. The host virtual bulletin board may be configured to display the virtual bulletin board 306 of the first individual on the display screen only in response to the server 202 receiving an opt-in request from the first individual, whereby the first individual opts to broadcast his or her virtual bulletin board 306 on the display screen at the event. In additional or further embodiments, the host virtual bulletin board 306 screen may be configured to display the virtual bulletin board 306 of the first individual only in response to the server 202 additionally or alternatively receiving a payment from the first individual.

In addition to the first individual, or any of the additional individuals, being able to submit a payment to have his or her virtual bulletin board 306 displayed on the display screen at the event, the first individual may also submit a payment to the server 202 for a more advanced virtual bulletin board 306. The more advanced virtual bulletin board 306 may be, for example, bigger or bolder. Of course, these examples are merely exemplary and are not limiting, exhaustive, or exclusive. For example, the virtual bulletin board 306 may be advanced by any known methods which are understood in the art such as, but not limited to, having more advanced or numerous features.

In an embodiment of the present application, the information exchange process 410 terminates upon an expiration of the predetermined timeframe 304. In this regard, the server 202 automatically deactivates the virtual bulletin board 306 of the first individual, and the virtual bulletin boards of the additional individuals which are participating in the information exchange session 300, during the deactivation process 412.

In deactivating the virtual bulletin board 306 of the first individual, the server 202 may delete the virtual bulletin board 306 or lock the virtual bulletin board 306 from further activity or editing. In the event that the server 202 locks, or freezes, the virtual bulletin board 306 of the first individual, the first individual may be permitted to view his or her virtual bulletin board 306 after the expiration of the predetermined timeframe 304. According to an embodiment of the present application, the first individual may be permitted to view his or her virtual bulletin board 306 after the expiration of the predetermined timeframe 304 only in response to submitting a payment to the server 202.

In embodiments of the present application, the first individual, and the additional individuals, may delay the expiration of the predetermined timeframe 304. In other words, the individuals may extend the predetermined timeframe 304. According to such embodiments, the server 202 may require that a payment be received for extending the predetermined timeframe 304. According to such an embodiment, the predetermined timeframe 304 may initially be less than or equal to a timeframe of the event. The predetermined timeframe 304 may be extended throughout the event by payment to the server in the event that the first individual, or the additional individuals, determines that the information exchange is worthwhile.

Moreover, according to an embodiment of the present application, the first individual, or the additional individuals, may even extend the predetermined timeframe 304 of another individual in the event that the first individual, or the additional individual, would like to continue the information exchange session 300 with that other individual.

In even further embodiments of the present application, the first individual, or the additional individuals, may even extend the predetermined timeframe 304 beyond an expiration of the event by submitting a payment to the server 202. As an alternative to extending the predetermined timeframe 304 beyond the expiration of the event or extending the predetermined timeframe 304 of another individual, the first individual may create a personal information exchange session and invite at least one other individual to participate in the personal information exchange session by submitting a payment to the server 202.

Additionally or alternatively to the above, the organizer, producer, or host of the event may submit a payment to the server 202 for extending the predetermined timeframe 304 of the event to which the information exchange session 300 is associated. According to such an embodiment, the individual participants of the information exchange session of the event may not be able to extend their respective predetermined timeframes by submitting a payment to the server 202, or the predetermined timeframes of the individual participants may be automatically extended upon the payment to the server 202 by the organizer, producer, or host of the event. Additionally or alternatively, the organizer, producer, or host of the event may extend the predetermined timeframe 304 of the event by submitting a payment to the server 202.

In further embodiments of the present application, during the information exchange process 410 and in accordance with the deactivation process 412, the server 202 may additionally or alternatively deactivate the virtual bulletin board 306 of the first individual, or any of the additional individuals, before the expiration of the predetermined timeframe 304 in response to the server 202 receiving a deactivation request from the first individual for deactivating his or her virtual bulletin board 306. In other words, the first individual may request that his or her virtual bulletin board 306 be prematurely deactivated before the expiration of the predetermined timeframe 304. According to such a feature, the first individual may escape or avoid harassing or unwanted behavior.

The server 202 may further prematurely deactivate the virtual bulletin board 306 of the first individual, or any of the additional individuals, during the information exchange process 410 and in accordance with the deactivation process 412 when the first individual leaves the geographic location 302 of the information exchange session 300 before the expiration of the predetermined timeframe 304. For example, according to an embodiment of the present application, the server 202 may deactivate the virtual bulletin board 306 of the first individual before the expiration of the predetermined timeframe 304 when the first individual completes a check-out process at the event. For example, if the first individual signs-out, collects his or her coat from a coat-check, or receives his or her parting gift or goodie-bag before the expiration of the predetermined timeframe 304, the server 202 may prematurely deactivate the virtual bulletin board 306 of the first individual.

According to a further embodiment of the present application, the server 202 may actively monitor a geolocation of the first individual, or any of the additional individuals, during the information exchange session 300 for determining whether the first individual prematurely leaves the geographic location 302 of the event. For example, the server may monitor a geolocation of a mobile device of the first individual during the information exchange session 300 by geotracking or geotagging. If the server 202 determines that the mobile device leaves the geographic location 302 of the event, the server 202 may prematurely deactivate the virtual bulletin board 306 of the first individual before the expiration of the predetermined timeframe 304.

In an embodiment of the present application, the server 202 may reactivate the virtual bulletin board 306 of the first individual in the event that the first individual returns to the geographic location 302 of the event. However, according to such an embodiment, the server 202 may require that the first individual submit a payment before reactivating the virtual bulletin board 306 of the first individual. With respect to the above-mentioned embodiments, the server 202 ensures that each of the registered and activated participants is physically present at the geographic location 302 of the event, thereby enhancing the participation and enjoyment in the information exchange session 300 for each of the participants.

Notwithstanding the above described embodiments of the present application, while the information exchange session 300 has generally been described as being associated with an event, those of ordinary skill in the art understand that the information exchange session 300 is not limited to be associated with an event. For example, the first individual may submit the registration request for joining an information exchange session 300 from a venue, such as a bar. In this regard, the information exchange session 300 need not correspond to any particular event at the venue, but rather, may merely be associated with the venue. Thereafter, any other individuals at the venue who submit a registration request for joining an information exchange session 300 may join the information exchange session 300 of the first individual. As a result, individuals that are at a same place at a same time may join a same information exchange session 300, without having to specify or indicate an event of the information exchange session 300.

In a further example, instead of being associated with a specific event or a specific venue, the information exchange session 300 may be associated with a general area. That is, the first individual may submit the registration request for joining an information exchange session 300 from a position, such as the position of the bar. Thereafter, any other individuals within a predetermined distance of that position who submit a registration request for joining an information exchange session 300 may join the information exchange session 300 of the first individual. As a result, individuals that are within a predetermined distance of one another may join a same information exchange session 300. According to such an embodiment, individuals that are located in a same area of a city, for example, my join a same information exchange session 300, even if they are not located at a same venue or event.

The present disclosure further provides various methods and processes for providing an information exchange session. Those skilled in the art appreciate that the various methods and processes are not limited to the features discussed below and that they may be implemented in accordance with the teachings and disclosure discussed above.

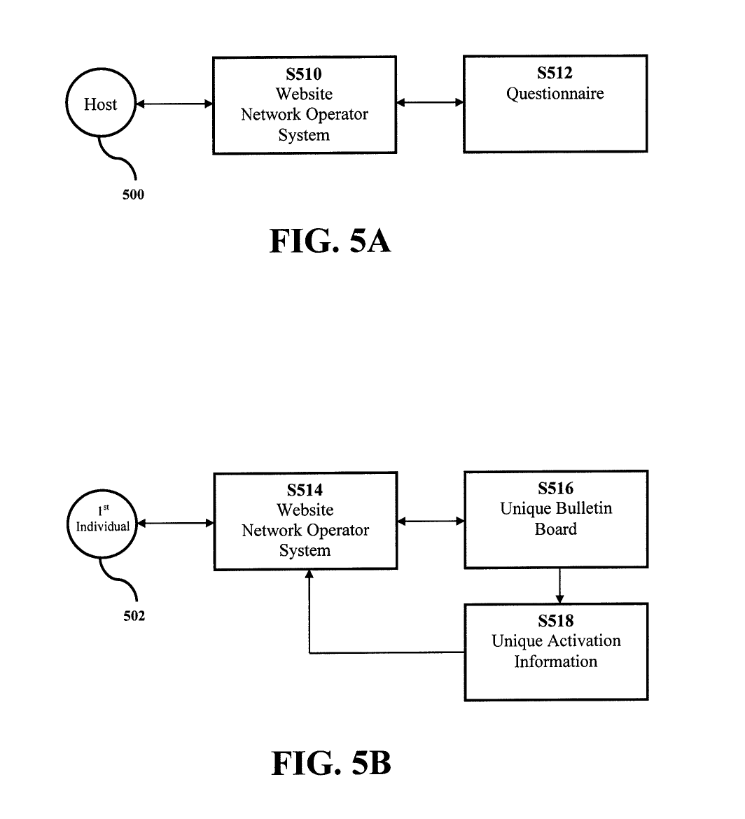

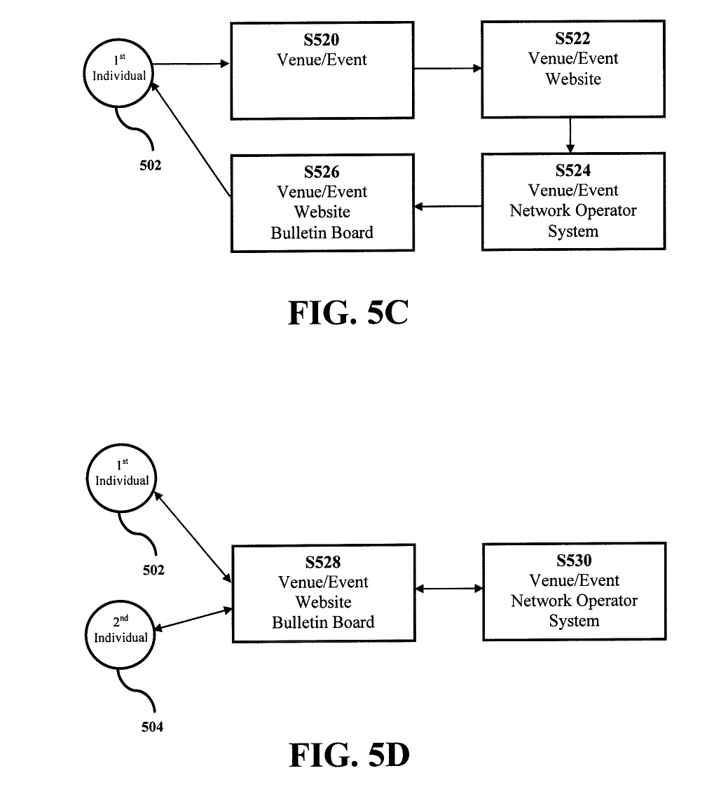

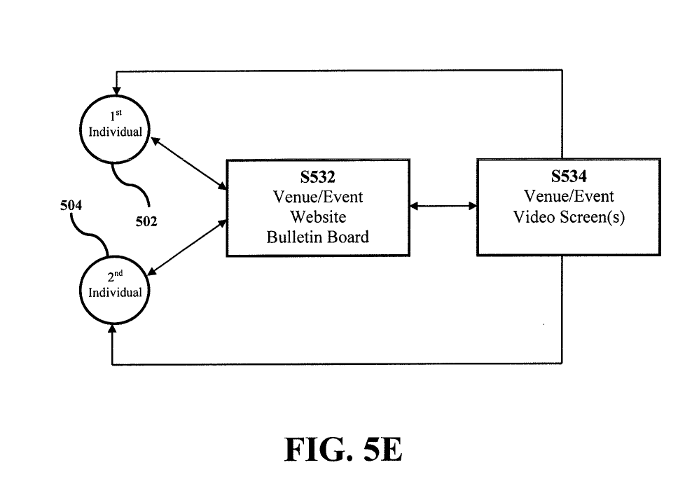

A general schematic of an exemplary process for providing an information exchange session is shown in FIGS. 5A-E. As shown in FIG. 5A, a host 500 accesses a website of a network operator system for registering an information exchange session at S510. The information exchange system is associated with a geographic location and has a predetermined timeframe. The host provides the network operator system with the geographic location and the predetermined timeframe via the website at S510, and the network operator system establishes the information exchange session in association with the geographic location and the predetermined timeframe. The network operator system may work with the host to create a questionnaire for completion by information exchange session participants when registering for the information exchange session at S512.

As shown in FIG. 5B, a first individual 502 accesses the website of the network operator system for registering for the information exchange session at S514. The first individual 502 completes the questionnaire and creates a unique virtual bulletin board via the website at S516. The unique virtual bulletin board of the first individual 502 may contain a limited amount of volunteered personal information. The unique virtual bulletin board may even be anonymous for protecting an identify of the first individual 502 for enabling the first individual to act comfortably in the information exchange session.

The network operator system provides the first individual 502 with unique activation information via the website at S518. The unique activation information is provided by the network operator system in response to the first individual completing his or her unique virtual bulletin board and registering for the information exchange session. The unique activation information may comprise a unique identifier code or be included within a mobile application. Of course, the network operator system may provide the unique activation information in additional or alternative known methods.

Thereafter, in FIG. 5C, the first individual 502 visits the geographic location that is associated with the information exchange session at S520. The geographic location may correspond to a specific venue or a particular event that is occurring at the geographic location during the predetermined timeframe. In other words, the information exchange session may generally be associated with the venue, during the predetermined timeframe, or the event.

The first individual accesses the website of the network operator system while at the venue or event at S522. In this regard, the first individual 502 may perform a check-in process at the venue or event to confirm a physical presence at the venue or event. The first individual 502 provides the network operator system with the unique activation information for activating the unique virtual bulletin board of the first individual 502 at S524. The network operator system activates the unique virtual bulletin board of the first individual 502 after confirming a validity of the unique activation information. Thereafter, the first individual 502 is able to access his or her unique virtual bulletin board while at the venue or event via the website for participating in the information exchange session at S526.

In FIG. 5D, the first individual 502 is registered and activated for participation in the information exchange session. A second individual 504 has also completed a registration process and an activation process for participation in the information exchange session. Each of the first individual 502 and the second individual 504 are able to access their respective unique virtual bulletin boards at the venue or event via the website at S528. The first individual 502 and the second individual 504 are also able to access one and others unique virtual bulletin boards at the venue or event via the website at S528 for communicating with one and other during the information exchange session. The degree of communication may remain as personal or anonymous as the first individual 502 and the second individual 504 would like. The network operator system maintains and monitors the communication of the first individual 502 and the second individual 504 at the venue or event via their respective virtual bulletin boards at S530.

As shown in FIG. 3E, each of the first individual 502 and the second individual 504 are able to access their unique virtual bulletin boards and one and others unique virtual bulletin boards at the venue or event via the website at S532 for communicating in the information exchange session. In this regard, the venue or event is provided with a unique host virtual bulletin board or similarly has access to the unique virtual bulletin boards of the first individual 502 and the second individual 504. The venue or event is able to display the unique host virtual bulletin board or the unique virtual bulletin board of any of the first individual 502 and the second individual 504 on a display screen at the venue or event at S534. The first individual 502 and the second individual 504 are each able to view the display screen at the venue or event.

Those of ordinary skill in the art appreciate that the above described process of FIGS. 5A-E is merely an exemplary process of the present application. Further embodiments of the process may be modified in accordance with any of the above-discussed teachings and disclosure of the present application, as well as in accordance with any known methods or teachings.

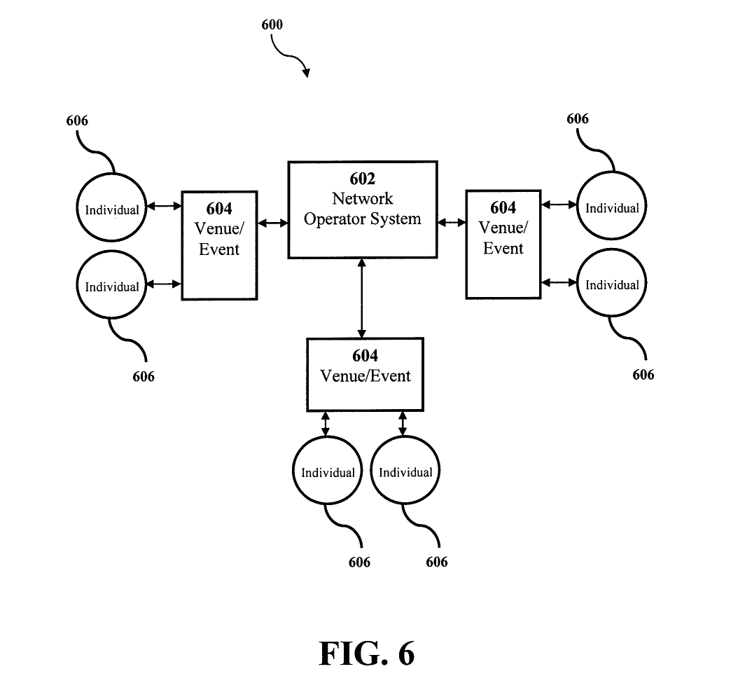

FIG. 6 discloses an exemplary schematic of a system 600 for providing a plurality of information exchange sessions. The system 600 includes a network operator system 602 that maintains and monitors the plurality of information exchange sessions. Each of the plurality of information exchange sessions is associated with a geographic location and has a predetermined timeframe. The plurality of information exchange sessions correspond to venues or events 604. In this regard, the venue of any information exchange session may correspond to the associated geographic location of the information exchange session, or the event of any information exchange session may correspond to an activity which occurs at the associated geographic location of the information exchange session during the associated predetermined timeframe of the information exchange session. A plurality of individuals 606 access the information exchange sessions which correspond to the venues or events 604 for participating in the information exchange sessions. In various embodiments of the system 600, the plurality of individuals 606 may access and participate in the information exchange sessions in accordance with any combination of features discussed herein.

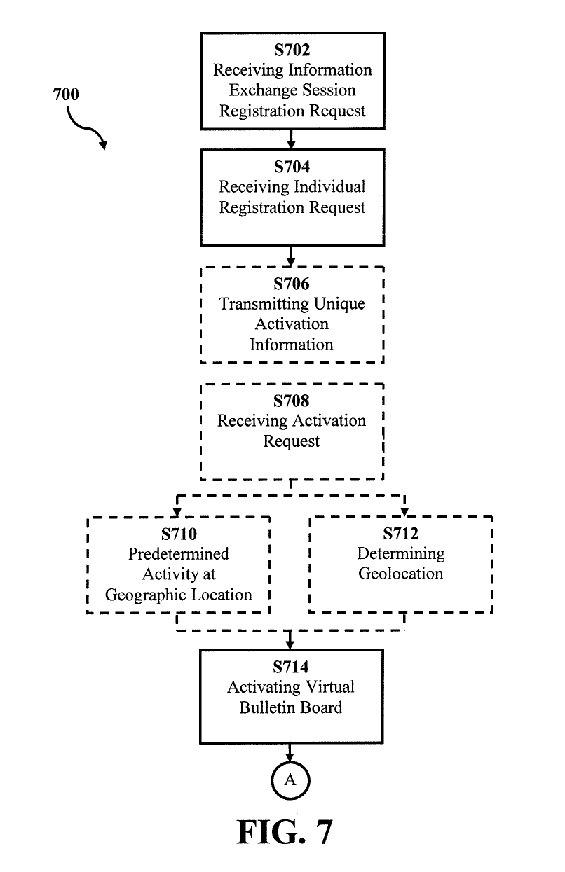

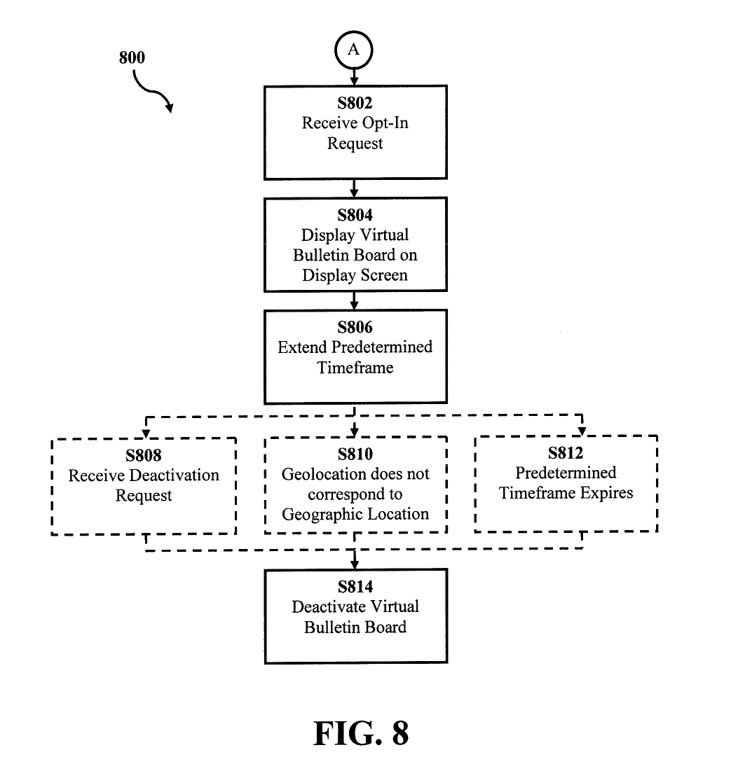

The present disclosure further provides various methods for providing an information exchange session. Those skilled in the art appreciate, of course, that the various methods may be implemented in accordance with the teachings and disclosure discussed above. FIGS. 7-8 disclose exemplary methods for providing an information exchange session.

According to the method 700 of FIG. 7, a server receives an information exchange session registration request from an organizer, a producer, or a host of an event at S702. The information exchange session is associated with a geographic location of the event and has a predetermined timeframe which corresponds to the event. After registration of the information exchange session for the event, the server may receive an individual registration request from a first individual for registering for the information exchange session at S704. The server registers the first individual for the information exchange session and activates a unique virtual bulletin board for the first individual at S706-S714.

In the embodiment of the method 700 of FIG. 7, the server transmits unique activation information to the first individual during a registration process at S706. Thereafter, when the first individual would like to participate in the information exchange session during the predetermined timeframe, the first individual transmits an activation request to the server for activating a unique virtual bulletin board of the first individual. The activation request includes the unique activation information which was transmitted to the first individual from the server. The server receives the activation request, including the unique activation information, and confirms a validity of the unique activation information for activating the unique virtual bulletin board of the first individual.

According to an embodiment of the method 700, the server may further require that the first individual perform a predetermined activity at the geographic location for confirming a physical presence of the first individual at the event at S710. In this regard, the server may require that the first individual check-in to the event for confirming the physical presence of the first individual at the event. Upon confirmation of the physical presence of the first individual at the event, the server may activate the unique virtual bulletin board of the first individual at S714.

In an additional or alternative embodiment of the method 700, the server may further actively monitor the first individual for confirming the physical presence of the first individual at the event at S712. For example, as shown in FIG. 7, the server may determine a geolocation of the first individual at S712. Thereafter, the server may confirm that the geolocation of the first individual corresponds to the geographic location of the event, and the server may activate the unique virtual bulletin board of the first individual accordingly at S714.

After activation of the unique virtual bulletin board of the first individual at S714, the first individual may participate in the information exchange session. The first individual and any other registered and activate participants of the event may exchange information via their respective unique virtual bulletin boards. As such, the first individual and the other registered and activate participants may interact initially and comfortably in a local setting.

In the method 800 of FIG. 800, after registration for the information exchange session and activation of the unique virtual bulletin board, the first individual may transmit an opt-in request to the server. The server receives the opt-in request at S802. In response to receiving the opt-in request, the server may display the unique virtual bulletin board of the first individual on a display screen at the event at S804.

In the method of 800 of FIG. 800, after registration for the information exchange session and activation of the unique virtual bulletin board, the first individual may also request that the predetermined timeframe of the information exchange session be extended. The server may receive a request for extending the predetermined timeframe of the information exchange session from the first individual at S806. In this regard, as discussed above, the server may require that a payment be submitted in conjunction with the request for extending the predetermined timeframe of the information exchange session.

During the information exchange session, the method of 800 of FIG. 800 may further monitor for activities which may terminate the information exchange session at S808-812. For example, according to one embodiment of the method 800, the server may receive a deactivation request from the first individual for prematurely deactivating his or her unique virtual bulletin board during the information exchange session before the expiration of the predetermined timeframe at S808. In response to receiving the deactivation request, the server prematurely deactivates the unique virtual bulletin board of the first individual at S814. In an additional or alternative embodiment of the method 800, the server may actively monitor a geolocation of the first individual. If the server detects that the geolocation of the first individual does not correspond to the geographic location of the event at S810, the server may prematurely deactivate the unique virtual bulletin board of the first individual at S814. In an even further additional or alternative embodiment of the method 800, the server may determine that the predetermined timeframe that is associated with the information exchange session expires at S812, and thereafter deactivate the unique virtual bulletin board of the first individual at S814.

Of course, those skilled in the art appreciate that the above-described methods 700 and 800 are merely exemplary and that the present disclosure includes various additional and alternative methods in accordance with the teachings and disclosure set forth herein. Moreover, those of ordinary skill in the art understand the various processes and methods described herein may be implemented by various computer programs and computer-readable media including executable instructions. The computer programs and computer-readable media, when executed, may implement any of the various processes, methods, or combinations thereof disclosed herein.

Accordingly, the present disclosure provides various systems, servers, methods, media, and programs for providing an information exchange session. Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A server for providing an information exchange session, the server comprising:
a network interface;
a processor; and
a memory including instructions that, when executed by the processor, cause the processor to execute operations comprising:
receiving, via a network and by the network interface, a registration request from a first individual for registering for the information exchange session, the information exchange session being associated with a geographic location and having a predetermined timeframe;
activating a virtual bulletin board of the first individual during the predetermined timeframe; and
deactivating the virtual bulletin board of the first individual at an end of the predetermined timeframe,
wherein the virtual bulletin board of the first individual is accessible during the predetermined timeframe and after activation via a network by at least one second individual that has registered for the information exchange session for exchanging information with the first individual.

2. The server according to claim 1, wherein the information exchange session is further associated with an event that is at the geographic location during the predetermined timeframe.

3. The server according to claim 2, wherein:
the operations further comprise:
transmitting, via the network and by the network interface, unique activation information to the first individual after receiving the registration request; and
receiving, via the network and by the network interface, an activation request from the first individual for joining the information exchange session during the predetermined timeframe, the activation request including the unique activation information of the first individual; and
determining whether the unique activation information included in the activation request is valid, and
the virtual bulletin board of the first individual is activated during the predetermined timeframe in response to receiving the activation request and determining that the unique activation information is valid.

4. The server according to claim 3, wherein the activation request includes the first individual executing a predetermined activity at the geographic location of the event for checking-in to the event.

5. The server according to claim 4, wherein:
the first individual executes the predetermined activity with a mobile device,
the operations further comprise determining a geolocation of the mobile device when the first individual executes the predetermined activity with the mobile device to confirm a presence of the first individual at the geographic location of the event, and
the virtual bulletin board of the first individual is activated during the predetermined timeframe only in response to confirming the presence of the first individual at the geographic location of the event.

6. The server according to claim 3, wherein:
the unique activation information that is transmitted to the first individual is a unique code, and
the activation request that is received from the first individual includes the unique code.

7. The server according to claim 3, wherein:
the unique activation information that is transmitted to the first individual is included in a mobile application that is transmitted to the first individual, and
the activation request of the first individual is received via the mobile application.

8. The server according to claim 7, wherein the activation request is automatically transmitted from the mobile application and received by the server when the mobile application is executed by the first individual.

9. The server according to claim 8, wherein:
the operations further comprise determining a geolocation of the mobile device when the mobile application is executed by the first individual to confirm a presence of the mobile device at the geographic location of the event, and
the virtual bulletin board of the first individual is activated during the predetermined timeframe only in response to confirming the presence of the mobile device at the geographic location of the event.

10. The server according to claim 3, wherein the operations further comprise:
receiving, via the network and by the network interface, a deactivation request from the first individual for deactivating the virtual bulletin board of the first individual before the end of the predetermined timeframe; and
deactivating the virtual bulletin board of the first individual before the end of the predetermined timeframe in response to receiving the deactivation request.

11. The server according to claim 3, wherein:
the first individual transmits the activation request with a mobile device, and
the operations further comprise:
monitoring a geolocation of the mobile device while the virtual bulletin board of the first individual is activated during the predetermined timeframe to determine whether the mobile device leaves the geographic location of the event; and
automatically deactivating the virtual bulletin board of the first individual before the end of the predetermined timeframe in response to determining that the mobile device leaves the geographic location of the event.

12. The server according to claim 2, wherein the predetermined timeframe of the information exchange session corresponds to a timeframe of the event.

13. The server according to claim 2, wherein:
the predetermined timeframe of the information exchange session is at most a timeframe of the event, and
the operations further comprise:
receiving, via the network and by the network interface, a payment from the first individual for extending the predetermined timeframe of the information exchange session; and
extending the predetermined timeframe of the information exchange session in response to receiving the payment from the first individual for extending the predetermined timeframe of the information exchange session.

14. The server according to claim 2, wherein:
the operations further comprise:
receiving, via the network and by the network interface, an event registration request from an organizer of the event for registering the event for the information exchange session; and
creating the information exchange session in response to the event registration request being received from the organizer of the event, and
the registration request from the first individual specifies the information exchange session.

15. The server according to claim 14, wherein:
the operations further comprise receiving, via the network and by the network interface, a payment from the organizer of the event in association with the event registration request from the organizer, and
the information exchange session is created only after receiving the payment in association with the event registration request.

16. The server according to claim 14, wherein:
the operations further comprise receiving, via the network and by the network interface, a template for the virtual bulletin board from the organizer of the event, the template including information fields specified by the organizer of the event, and
the first individual completes the information fields during a registration process.

17. The server according to claim 2, wherein the virtual bulletin board of the first individual is configured to be broadcast on a display at the event.

18. The server according to claim 17, wherein:
the operations further comprise receiving, via the network and by the network interface, an opt-in request from the first individual for opting to broadcast the virtual bulletin of the first individual on the display at the event, and
the virtual bulletin board of the first individual is broadcast on the display at the event only in response to the opt-in request being received from the first individual.

19. The server according to claim 17, wherein:
the operations further comprise receiving, via the network and by the network interface, a display payment from the first individual for broadcasting the virtual bulletin board of the first individual on the display at the event, and
the virtual bulletin board of the first individual is broadcast on the display at the event in response to the display payment being received from the first individual.

20. The server according to claim 2, wherein a list that identifies the first individual and the at least one second individual is configured to be broadcast on a display at the event.

21. The server according to claim 1, wherein:
the geographic location that is associated with the information exchange session corresponds to a venue from where the registration request is received from the first individual, and
the at least one second individual registers for the information exchange session by submitting a second registration request from the venue from where the registration request is received from the first individual.

22. The server according to claim 1, wherein:
the geographic location that is associated with the information exchange session corresponds to a position from where the registration request is received from the first individual, and
the at least one second individual registers for the information exchange session by submitting a second registration request from within a predetermined distance of the position from where the registration request is received from the first individual.

23. The server according to claim 1, wherein the registration request includes personal information provided by the first individual.

24. The server according to claim 23, wherein the personal information provided by the first individual is anonymous about an identity of the individual and the virtual bulletin board of the first individual does not identify the identity of the first individual.

25. A method for providing an information exchange session, comprising:
receiving, via a network and by a network interface, a registration request from a first individual for registering for the information exchange session, the information exchange session being associated with a geographic location and having a predetermined timeframe;
activating, by a processor, a virtual bulletin board of the first individual during the predetermined timeframe; and
deactivating, by the processor, the virtual bulletin board of the first individual at an end of the predetermined timeframe,
wherein the virtual bulletin board of the first individual is accessible during the predetermined timeframe and after activation via a network by at least one second individual that has registered for the information exchange session for exchanging information with the first individual.

26. The method according to claim 25, wherein the information session corresponds to an event that is at the geographic location.

27. The method according to claim 26, further comprising:
transmitting, via the network and by the network interface, unique activation information to the first individual after receiving the registration request;
receiving, via the network and by the network interface, an activation request from the first individual for joining the information exchange session during the predetermined timeframe, the activation request including the unique activation information of the first individual; and
determining, by the processor, whether the unique activation information included in the activation request is valid,
wherein the virtual bulletin board of the first individual is activated during the predetermined timeframe in response to receiving the activation request and determining that the unique activation information is valid.

28. The method according to claim 27, wherein the activation request includes the first individual executing a predetermined activity at the geographic location of the event for checking-in to the event.

29. The method according to claim 28, wherein:
the first individual executes the predetermined activity with a mobile device,
the method further comprises determining a geolocation of the mobile device when the first individual executes the predetermined activity with the mobile device to confirm a presence of the first individual at the geographic location of the event, and
the virtual bulletin board of the first individual is activated during the predetermined timeframe only in response to confirming the presence of the first individual at the geographic location of the event.

30. The method according to claim 27, wherein:
the unique activation information that is transmitted to the first individual via the network interface is a unique code, and
the activation request that is received from the first individual via the network interface includes the unique code.

31. The method according to claim 27, wherein:
the unique activation information that is transmitted to the first individual is included in a mobile application that is transmitted to the first individual, and
the activation request of the first individual is received via the mobile application.

32. The method according to claim 31, wherein the activation request is automatically transmitted from the mobile application and received by the server when the mobile application is executed by the first individual.

33. The method according to claim 32, further comprising:
determining a geolocation of the mobile device when the mobile application is executed by the first individual to confirm a presence of the mobile device at the geographic location of the event, and
activating the virtual bulletin board of the first individual during the predetermined timeframe only in response to confirming the presence of the mobile device at the geographic location of the event.

34. A non-transitory computer readable medium including an executable set of instructions for providing an information exchange session that, when executed by a processor, causes the processor to execute operations comprising:
receiving a registration request from a first individual for registering for the information exchange session, the information exchange session being associated with a geographic location and having a predetermined timeframe;
activating a virtual bulletin board of the first individual during the predetermined timeframe; and
deactivating the virtual bulletin board of the first individual at an end of the predetermined timeframe,
wherein the virtual bulletin board of the first individual is accessible during the predetermined timeframe and after activation via a network by at least one second individual that has registered for the information exchange session for exchanging information with the first individual.

35. The non-transitory computer readable medium according to claim 34, wherein the information session corresponds to an event that is at the geographic location.

36. The non-transitory computer readable medium according to claim 35, wherein:
the operations further comprise:
transmitting unique activation information to the first individual in response to receiving the registration request;
receiving an activation request from the first individual for joining the information exchange session during the predetermined timeframe, the activation request including the unique activation information of the first individual; and
determining whether the unique activation information included in the activation request is valid, and
the virtual bulletin board of the first individual is activated during the predetermined timeframe in response to receiving the activation request and determining that the unique activation information is valid.

37. The non-transitory computer readable medium according to claim 36, wherein the activation request includes the first individual executing a predetermined activity at the geographic location of the event for checking-in to the event.

38. The non-transitory computer readable medium according to claim 37, wherein:
the first individual executes the predetermined activity with a mobile device,
the operations further comprise determining a geolocation of the mobile device when the first individual executes the predetermined activity with the mobile device to confirm a presence of the first individual at the geographic location of the event, and
the virtual bulletin board of the first individual is activated during the predetermined timeframe only in response to confirming the presence of the first individual at the geographic location of the event.

39. The non-transitory computer readable medium according to claim 36, wherein:
the unique activation information that is transmitted to the first individual is a unique code, and
the activation request that is received from the first individual includes the unique code.

40. The non-transitory computer readable medium according to claim 36, wherein:
the unique activation information that is transmitted to the first individual is included in a mobile application that is transmitted to the first individual, and
the activation request of the first individual is received via the mobile application.

41. The non-transitory computer readable medium according to claim 40, wherein the activation request is automatically transmitted from the mobile application and received by the server when the mobile application is executed by the first individual.

42. The non-transitory computer readable medium according to claim 41, wherein:
the operations further comprise determining a geolocation of the mobile device when the mobile application is executed by the first individual to confirm a presence of the mobile device at the geographic location of the event, and
the virtual bulletin board of the first individual is activated during the predetermined timeframe only in response to confirming the presence of the mobile device at the geographic location of the event.
